(19) United States
(12) Patent Application Publication
(10) Pub. No.: US 2006/0061287 A1
(43) Pub. Date: Mar. 23, 2006

(54) Plasma processing apparatus and control method thereof

(76) Inventors: Sang Jean Jeon, Suwon City (KR); Chin Wook Chung, Seoul (KR); Do Young Kam, Suwon-City (KR)

Correspondence Address: STANZIONE & KIM, LLP, 919 18TH STREET, N.W., SUITE 440, WASHINGTON, DC, 20006, US

(21) Appl. No.: 11/076,922

(22) Filed: Mar. 11, 2005

(30) Foreign Application Priority Data
Sep. 20, 2004 (KR) 2004-75198

(51) Int. Cl. H01J 7/24

(52) U.S. Cl. 315/111.21

(57) ABSTRACT

A plasma processing apparatus effectively generates plasma in a large area by applying an external magnetic field generated by an electromagnet to the plasma in a direction which is not in parallel with a wall of a plasma container, such that the magnetic field diverge or converge in the vicinity of a work piece (for example, a wafer). The plasma processing apparatus includes a power supply to generate a high frequency power, an antenna to receive the high frequency power and to generate an electromagnetic field, a chamber to generate the plasma using power generated through the electromagnetic field, and a coil provided on a side wall of the chamber to disrupt a uniformity of the electromagnetic field within the chamber.

### CROSS-REFERENCE TO RELATED APPLICATIONS

This application claims the benefit of Korean Patent Application No. 2004-75198, filed on Sep. 20, 2004 in the Korean Intellectual Property Office, the disclosure of which is incorporated herein in its entirety and by reference.

### BACKGROUND OF THE INVENTION

1. Field of the Invention

The present general inventive concept relates to a plasma processing apparatus and a control method thereof, and more particularly, to a plasma generating apparatus to increase a plasma density and enhance a uniformity of the plasma density in a chamber.

2. Description of the Related Art

Generally, an etching process of a semiconductor manufacturing process is required to selectively remove a thin film immediately under a photoresist layer, the thin film being made of a photosensitivity resin to be etched through openings of the photoresist layer. A plasma etching method is one of a number of dry etching methods commonly used in the semiconductor manufacturing process.

The term “plasma” represents ionized gas consisting of positive ions, negative ions and neutral particles, and “plasma” is said to be the fourth state of matter since it is much different in its electric and thermal nature from normal gas. More specifically, since the plasma includes the ionized gas, when an electric field or a magnetic field is applied to the plasma, plasma particles are accelerated or diffused to a surface of a solid body which is contained in or in contact with the plasma to cause a chemical or physical reaction with the surface of the solid body.

The plasma is classified into a low-temperature glow discharge plasma having a temperature of several tens of thousands of degrees and a density of 10⁹ to 10¹⁰ cm⁻³ and a super high temperature nuclear fusion plasma having a temperature of several tens of millions of degrees and a density of 10¹³ to 10¹⁴ cm⁻³. Of these plasma, the low-temperature glow discharge plasma, having a low ionization degree and including neutral gas of more than 90%, is used for semiconductor etching or deposition.

Recently, a dry etching process using a plasma apparatus to generate a high density plasma is being increasingly used in the semiconductor manufacturing process. This is because a need of micro-machining is increased with an increase of a degree of integration of a semiconductor device. In other words, for a fine pattern in a sub-micro range, a mean free path in the plasma must be long in order to secure verticality of an etching cross-section, and, to this end, the high density plasma is required. In addition, as a large diameter wafer having a diameter of more than 8 inches is increasingly used, a need for uniformity of a plasma density is increased. Particularly in a case of a manufacturing process of a flat panel display of various shapes including a thin-film transistor liquid crystal display (TFT-LCD), a plasma display panel (PDP), a field emission display (FED), etc., since a substrate having a large area over a silicon wafer is used as a work piece, and the substrate is one of a circular substrate and a rectangular substrate, it is very important to maintain a uniform and high density plasma at an edge portion of a chamber as well as a center portion of the chamber.

The high density plasma includes an electron cyclotron resonance (ERC) plasma using resonance caused by applying a microwave having a resonance frequency when electrons introduced into a space in which a magnetic field is generated are rotated on a circular orbit according to Lorenz's law, a helicon plasma using a helicon or Whistler wave, and an inductively coupled plasma using a high-temperature and low-pressure plasma. The ERC plasma has an advantage in that the high density plasma is generated, even under low pressure; however, it has a disadvantage in that it is difficult to obtain uniform distribution of the plasma. In addition, the helicon plasma has an advantage in that it can generate uniformly distributed high density plasma in a small area of plasma by exciting plasma by applying a combination of an electric field and a magnetic field to the plasma. However, it has a disadvantage in that a distribution of the high density plasma in a large area of plasma lacks uniformity.

### SUMMARY OF THE INVENTION

The present general inventive concept provides a plasma processing apparatus to generate plasma in a large area by applying an external magnetic field generated by an electromagnet to the plasma in a direction not parallel to a wall of a plasma container, such that the magnetic field diverges or converges in the vicinity of a work piece (for example, a wafer).

Additional aspects and/or advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a plasma processing apparatus including a power supply to generate high frequency power, an antenna to receive the high frequency power and to generate an electromagnetic field, a chamber to generate plasma using power generated through the electromagnetic field, and a coil provided on a side wall of the chamber to disrupt a uniformity of the electromagnetic field within the chamber.

The foregoing and/or other aspects and advantages of the present general inventive concept may also be achieved by providing a plasma processing apparatus including a power supply to generate high frequency power, an antenna to receive the high frequency power and to generate an electromagnetic field, a chamber to generate plasma using power generated through the electromagnetic field, and a coil provided on a side wall of the chamber to disrupt a uniformity of the electromagnetic field within the chamber, wherein the plasma is generated using a magnetic field generated by the coil and an electron cyclotron resonance of electrons.

The foregoing and/or other aspects and advantages of the present general inventive concept may also be achieved by providing a plasma processing apparatus including a power supply to generate high frequency power, an antenna to receive the high frequency power and to generate an electromagnetic field, a chamber to generate plasma using power generated through the electromagnetic field, and a coil provided on a side wall of the chamber to disrupt a uniformity of the electromagnetic field within the chamber, wherein the plasma is generated by a cavity resonance caused by an interaction between electromagnetic waves propagating within the plasma and one or more inner walls of the chamber.

The foregoing and/or other aspects and advantages of the present general inventive concept may also be achieved by providing a control method of a plasma processing apparatus, the method including generating an electromagnetic field by supplying high frequency power to an antenna, generating plasma within a chamber by supplying power generated through the electromagnetic field to the chamber, and applying a magnetic field to the chamber using a coil to cause a lack of uniformity in the electromagnetic field.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating a plasma processing apparatus according to an embodiment of the present general inventive concept;

FIGS. 2A and 2B are schematic diagrams showing electromagnetic field distributions diverging and converging, respectively, within the plasma processing apparatus of FIG. 1;

FIG. 2C is a schematic diagram showing an electromagnetic field distribution of a conventional plasma processing apparatus; and

FIG. 3 is a schematic diagram showing plasma densities according to the electromagnetic field distributions shown in FIGS. 2A and 2B.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

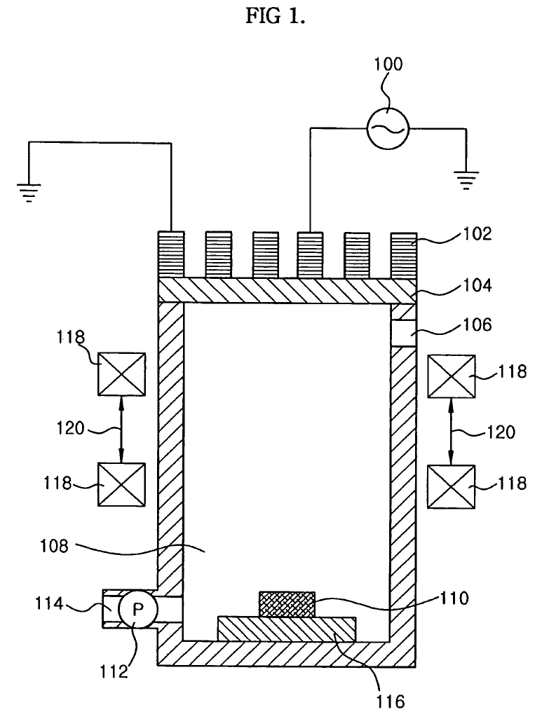

FIG. 1 is a schematic diagram illustrating a plasma processing apparatus according to an embodiment of the present general inventive concept. Referring to FIG. 1, the plasma processing apparatus includes a chamber 108 in which plasma is generated. An interior of the chamber 108 is isolated from the atmosphere by a wall of the chamber 108 to maintain a vacuum state. The chamber 108 is prepared with a gas injection port 106 through which a reactive gas is introduced, an exhaust pump 112 to exhaust the reactive gas within the chamber 108 when a reaction in the chamber ends, and a gas exhaust port 114. In addition, a chuck 116, on which a work piece 110, such as a wafer or a glass substrate, is placed, is disposed inside the chamber 108. Antennas 102, to which high frequency power is supplied from a power source 100, are provided in the top of the chamber 108. A quartz window 104 is provided between the antennas 102 and the chamber 108 to interrupt a capacitive coupling between the antennas 102 and the plasma inside the chamber 108 so that energy from the high frequency power is delivered to the plasma through only an inductive coupling. The chamber 108 is surrounded by one or more coils 118 to generate a diverging or converging direct current magnetic field that lacks uniformity. An electromagnetic field generated by the antennas 102 within the chamber 108 diverges or converges along with the diverging or converging magnetic field. The divergence or convergence of the electromagnetic field within the chamber 108 is controlled by adjusting a vertical gap 120 between the coils 118. If the vertical gap 120 between the coils 118 is too large, the electromagnetic field diverges in a middle part of the chamber 108. It is possible to cause the electromagnetic field to diverge or converge to a lower part of the chamber 108 by appropriately adjusting a position of the coils 118 and the vertical gap 120. A horizontal gap between the wall and the coils 118 may be adjusted to cause the electromagnetic field to be changed.

The plasma processing apparatus as described above initially operates the exhaust pump 112 to turn the interior of the chamber 108 into the vacuum state, injects the reactive gas to generate the plasma into the chamber 108 through the gas injection port 104, and then applies the high frequency power to the antennas 102. When the high frequency power is applied, a magnetic field varying with time in a direction perpendicular to a plane on which the antennas 102 are placed is generated and induces an electric field inside the chamber 108. The induced electric field accelerates particles of the reactive gas within the chamber 108. The accelerated particles collide with each other to produce plasmalized ions and radicals to be used to etch and depose the work piece.

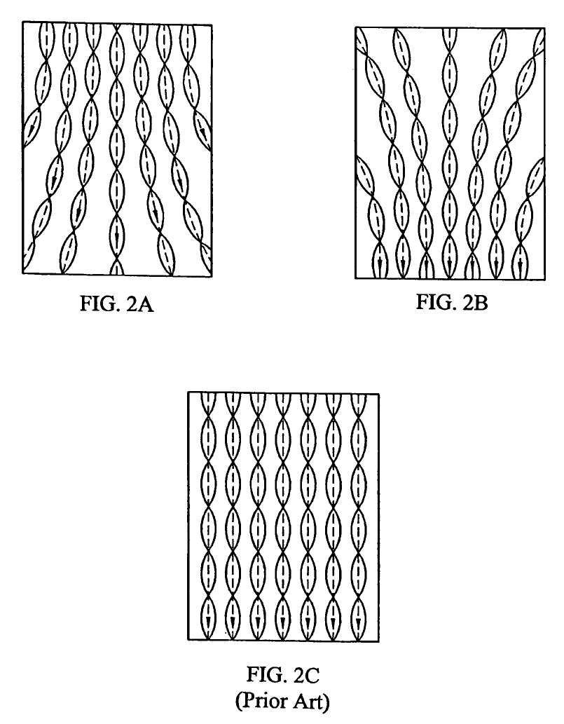

The divergence and convergence of the electromagnetic field within the chamber 108 by action of the one or more coils 118 in the plasma processing apparatus are shown in FIGS. 2A and 2B. FIGS. 2A and 2B are schematic diagrams showing electromagnetic field distributions diverging and converging, respectively, within the chamber 108 of the plasma processing apparatus of FIG. 1. FIG. 2C is a schematic diagram showing an electromagnetic field of a conventional plasma processing apparatus, which has a uniform distribution in parallel with a wall of a chamber of the conventional plasma processing apparatus.

An inductively coupled plasma is plasma generated by an inductive electric field instead of a capacitive electric field, and a plasma potential thereof is determined regardless of potentials of the antennas. Accordingly, the inductively coupled plasma generates a high density plasma since it has an ion energy loss that is approximately ten times less than that of a capacitively coupled plasma. Such an inductively coupled plasma is widely used in a plasma etching process since the inductively coupled plasma can control an ion energy and an ion flux independently.

The plasma processing apparatus of FIG. 1 can be regarded as a transformer having the antennas 102 as a primary winding and the plasma within the chamber 108 as a secondary winding from a point of view of an electric circuit. A power transfer efficiency of the transformer is deteriorated when a resistance of the secondary winding (i.e. the plasma) is either very high or very low. In order to generate the plasma more efficiently, it is important to maximize a coupling constant of the transformer. The coupling constant can become large by decreasing a gap between the antennas 102 and the plasma and/or by controlling a current to flow through a wider area of the secondary winding (the plasma). In order to decrease the gap between the antennas 102 and the plasma, a thickness of the quartz window 104 can be decreased. However, for the purpose of maintaining a vacuum within the chamber 108, there may be a limitation to the decrease of the thickness of the quartz window 104. Accordingly, it is possible to apply a magnetic field such that the current flows through the wider area of the plasma.

When the magnetic field is applied to the chamber 108, an electromagnetic wave can propagate within the plasma. When the propagating electromagnetic wave forms a node that becomes zero at the bottom of the chamber 108, a maximum of power is delivered to the plasma. However, since a wavelength of the propagating electromagnetic wave is a function of a plasma density, and standing waves can be generated only at a certain length, the plasma may be unstable under certain conditions. Namely, as shown in FIG. 2C, although high density plasma can be generated when nodes of all electromagnetic waves become zero at the bottom of the chamber 108, since it is difficult to precisely adjust wavelengths of all electromagnetic waves, the electromagnetic waves diverge (FIG. 2A) or converge (FIG. 2B) such that some of the electromagnetic waves become zero at the bottom or a side wall of the chamber 108, as shown in FIGS. 2A and 2B. Accordingly, by adjusting a degree of divergence or convergence of the electromagnetic waves, the high density plasma can be generated, and moreover, an effective range of the high density plasma can be further widened.

Electrons and ions are subject to a cyclotron movement by the magnetic field. The electrons are accelerated by a strong electric field caused by the high frequency electromagnetic waves (referred to as “electron cyclotron resonance”). Since the electron cyclotron resonance can be well generated within the chamber 108 in the magnetic field divergence as shown in FIG. 2A, a power delivery to the plasma can be maximized with more efficiency. In addition, the plasma can be generated by a cavity resonance caused by an interaction between the electromagnetic waves propagating within the plasma and one or more inner walls of the chamber.

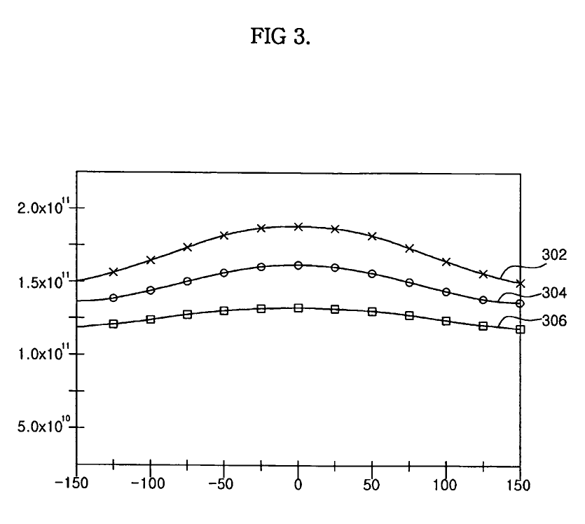

FIG. 3 is a schematic diagram showing plasma densities according to the electromagnetic field distributions shown in FIGS. 2A and 2B, where a horizontal axis denotes a position within the chamber and a vertical axis denotes the plasma density. As shown in FIG. 3, the plasma density is uniform through center and peripheral portions of the chamber and is very high due to the lack of the uniformity in the electromagnetic field. In the schematic diagram of FIG. 3, the intensity of the magnetic field becomes strong in an order of reference numerals 306>304>302 depending on the adjustment of uniformity in the electromagnetic field.

As described above, the present general inventive concept provides a plasma processing apparatus and a control method thereof, which are capable of enhancing uniformity by increasing diffusion of a plasma toward a center portion of a chamber and preventing a diffusion of the plasma toward inner walls of the chamber using a diverging or converging magnetic field that lacks uniformity. In addition, since an electron cyclotron resonance can be generated in a desired wide area or a desired particular region by adjusting a degree of the divergence or convergence of the magnetic field, an entire plasma uniformity and a plasma absorption power can be greatly enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A plasma processing apparatus comprising:
a power supply to generate a high frequency power;
an antenna to receive the high frequency power and to generate an electromagnetic field;
a chamber to generate plasma using a power generated through the electromagnetic field; and
a coil provided on a side wall of the chamber to disrupt a uniformity of the electromagnetic field within the chamber.

2. The plasma processing apparatus as set forth in claim 1, wherein the coil causes the electromagnetic field within the chamber to diverge.

3. The plasma processing apparatus as set forth in claim 1, wherein the coil causes the electromagnetic field within the chamber to converge.

4. The plasma processing apparatus as set forth in claim 1, wherein the chamber generates the plasma using a magnetic field generated by the coil and an electron cyclotron resonance of electrons.

5. The plasma processing apparatus as set forth in claim 1, wherein the chamber generates the plasma by using a cavity resonance caused by an interaction between one or more electromagnetic waves propagating within the plasma and one or more inner walls of the chamber.

6. A plasma processing apparatus comprising:
a power supply to generate a high frequency power;
an antenna to receive the high frequency power and to generate an electromagnetic field;
a chamber to generate plasma using power generated through the electromagnetic field; and
a coil provided on a side wall of the chamber to disrupt a uniformity of the electromagnetic field within the chamber,
wherein the plasma is generated using a magnetic field generated in the coil and an electron cyclotron resonance of one or more electrons.

7. A plasma processing apparatus comprising:
a power supply to generate high frequency power;
an antenna to receive the high frequency power and to generate an electromagnetic field;
a chamber to generate plasma using power generated through the electromagnetic field; and
a coil provided on a side wall of the chamber to disrupt a uniformity of the electromagnetic field within the chamber,
wherein the plasma is generated by a cavity resonance caused by an interaction between electromagnetic waves propagating within the plasma and one or more inner walls of the chamber.

8. A plasma processing apparatus comprising:
an antenna to generate an electromagnetic field in a first direction;
a chamber to generate a plasma using power generated through the electromagnetic field; and
one or more coils to apply a magnetic field to the electromagnetic field in the chamber in a second direction to adjust the first direction of the electromagnetic field.

9. The plasma processing apparatus as set forth in claim 8, wherein the magnetic field is one of a diverging direct current non-uniform magnetic field and a converging direct current non-uniform magnetic field.

10. The plasma processing apparatus as set forth in claim 8, wherein the magnetic field controls the electromagnetic field such that nodes of electromagnetic waves become zero at a wall of the chamber.

11. The plasma processing apparatus as set forth in claim 8, wherein the magnetic field causes the electromagnetic field to diverge or converge with respect to an inside of the chamber.

12. The plasma processing apparatus as set forth in claim 8, wherein the one or more coils controls electromagnetic waves to diverge or converge such that a high density plasma is generated according to an adjustment of a degree of the divergence or convergence of the electromagnetic waves.

13. The plasma processing apparatus as set forth in claim 8, wherein the one or more coils controls the electromagnetic field with the magnetic field such that diffusion of a plasma within the chamber is increased toward a center portion of the chamber and prevented toward inner walls of the chamber to enhance uniformity of the plasma formed on a work piece.

14. The plasma processing apparatus as set forth in claim 8, wherein the chamber comprises a sidewall, and the first direction of the electromagnetic field is adjusted not to be parallel to the sidewall.

15. The plasma processing apparatus as set forth in claim 8, wherein the chamber comprises a sidewall, and wherein the one or more coils are disposed along the sidewall of the chamber.

16. The plasma processing apparatus as set forth in claim 8, wherein the one or more coils comprises a first coil and a second coil spaced-apart from each other by a gap.

17. The plasma processing apparatus as set forth in claim 16, wherein the gap is adjusted to adjust the first direction of the electromagnetic field.

18. The plasma processing apparatus as set forth in claim 16, wherein the gap is adjusted to control the electromagnetic field to diverge or converge with respect to the chamber.

19. The plasma processing apparatus as set forth in claim 8, wherein the magnetic field disrupts a uniformity of the electromagnetic field.

20. A control method of a plasma processing apparatus, comprising:
generating an electromagnetic field by supplying high frequency power to an antenna;
generating plasma within a chamber by supplying power generated through the electromagnetic field to the chamber; and
applying a magnetic field that lacks uniformity to the chamber through a coil such that the electromagnetic field lacks uniformity.
